(19) United States
(12) Patent Application Publication
(10) Pub. No.: US 2019/0035019 A1
(43) Pub. Date: Jan. 31, 2019

(54) OVER THE COUNTER BARTER SYSTEM MARKET PLACE AND METHODS

(71) Applicant: Majid Reza JALALI, Dubai (AE)

(72) Inventor: Majid Reza JALALI, Dubai (AE)

(21) Appl. No.: 15/878,721

(22) Filed: Jan. 24, 2018

Related U.S. Application Data
(60) Provisional application No. 62/536,689, filed on Jul. 25, 2017.

(51) Int. Cl. G06Q 40/04

(52) U.S. Cl. CPC G06Q 40/04

(57) ABSTRACT

Systems, methods and computer-readable mediums are disclosed for receiving a first trading order from a first market participant, performing a first process for enabling a bartering of the first trading order with at least one second trading order received from a second market participant, and when the first process does not result in a complete clearing of the first trading order, performing a second process to clear any remaining portion of the first trading order through at least one liquidity provider registered with the trading platform.

### TECHNICAL FIELD

The present technology pertains to a system that provides a multi-level automated and self-sufficient financial market place.

### BACKGROUND

Over the Counter (OTC) markets present platforms (typically an online platform where trades are done electronically) and a way of transaction where currencies, commodities, stocks and other financial instruments are sold through a network of dealers and not through a formal exchange (like London Stock Exchange (LSE), New York Stock Exchange (NYSE), etc.). Unlike these formal exchanges, OTC markets are typically a “non-standardized platform or means of exchange and trade”. OTC markets provide and facilitate flexible market entry/exit for their participants. In the early days of OTC markets, all participants acted as an arm of the market in a non-centralized manner therefore permitting market players to build their own tailor-made contracts and flexible terms and conditions for participation.

Over the past decades and due to market integration aided by the emergence of various communication channels, many OTC markets have joined forces effectively forming a network of OTC markets, the continuous expansion of which is accelerated and aided by the exponential growth and prevalence of the internet and its direct application to markets and trading. Therefore, within a short span of time, OTC markets turned into large network(s) of companies, banks, brokerage, liquidity providers and other active market participants. Due to an increased client base, the volume of trades has grown substantially in OTC markets. Given the limited number of liquidity providers available in OTC markets, relative to other market participants, (e.g., retail, institutional and individual investors/participants), OTC markets have become a non-centralized (but effectively acting in a centralized manner) market of a few large players (liquidity providers) that manage and control over hundreds of thousands of market participants. The current structure has inherent risks, which are listed below.

First, clients typically have brokers as their counterparty and brokers in turn have liquidity providers and banks as their counterparty. In the event of a financial hardship or bankruptcy of any of the liquidity providers or banks, the effect can be immediately felt by the brokers and ultimately their clients.

Second, due to various reasons (political, economic, etc.), markets tend to be inherently volatile. Since there are limited number of counterparties in OTC markets and a disparity in terms of the number of clients and brokers versus the number of liquidity providers and banks, the risk level increases and in effect, each layer of the market carries its own risks as well as the risks that are “passed down” from the top in what is effectively a vertical flow of risk.

Third, to attract clients, brokers must offer a relatively high leverage to the clients. The leverage that the broker would receive from a liquidity provider will be significantly lower (e.g., in the range of 1:10 to 1:20). Accordingly, at any given time, the volume of trades far exceeds the available liquidity that can be reasonably furnished and made available to traders by liquidity providers and the banks.

Fourth, the disparities in the leverage levels that brokers offer and receive, as described above, create cash flow issues for the brokers and hence forces them to keep some of the trades in house and not pass them on. This is very risky for the stability of OTC markets.

Fifth, there are fewer risk takers (e.g., Liquidity Providers and Banks) in OTC markets as compared to other market players. Occasionally and in order to manage and mitigate their own respective risk, these risk takers change their trading rules, terms and condition which unilaterally protects and serves their interests but is very difficult for the retail brokers to accept, adopt, and comply with, since their interests conflict with those of the risk takers. This has created a big gap between the market layers.

Accordingly, a better OTC market system is needed to address the disparities and the inherent risks of current markets described above.

### BRIEF DESCRIPTION OF THE DRAWINGS

In order to describe the manner in which the above recited and other advantages and features of the disclosure can be obtained, a more particular description of the principles briefly described above will be rendered by reference to specific examples thereof which are illustrated in the appended drawings. Understanding that these drawings depict only examples of the disclosure and are not therefore to be considered to be limiting of its scope, the principles herein are described and explained with additional specificity and detail through the use of the accompanying drawings in which:

FIG. 1 illustrates an example of a market place, according to an aspect of the present disclosure;

FIG. 2 illustrates components of a network device, according to an aspect of the present disclosure;

FIG. 3 illustrates a method according to an aspect of the present disclosure; and

FIG. 4 describes a method of facilitating and managing trades by OBS core of FIG. 1, according to an aspect of the present disclosure.

### DETAILED DESCRIPTION

### Overview

In one aspect, a system includes at least one memory having computer-readable instructions stored therein and one or more processors configured to execute the computer-readable instructions to receive a first trading order from a first market participant, perform a first process for enabling a bartering of the first trading order with at least one second trading order received from a second market participant, and when the first process does not result in a complete clearing of the first trading order, perform a second process to clear any remaining portion of the first trading order through at least one liquidity provider registered with the trading platform.

In another aspect, a non-transitory computer-readable, medium having computer-readable instructions stored thereon, which when executed by one or more processors, cause the one or more processors to receive a first trading order from a first market participant, perform a first process for enabling a bartering of the first trading order with at least one second trading order received from a second market participant, determine whether the first process resulted in a complete clearing of the first trading order, to yield a determination, and perform a second process to clear any remaining portion of the first trading order through at least one liquidity provider registered with the trading platform based on the determination.

In another aspect, a method includes receiving a first trading order from a first market participant, performing a first process for enabling a bartering of the first trading order with at least one second trading order received from a second market participant, determining whether the first process resulted in a complete clearing of the first trading order, to yield a determination, and performing a second process to clear any remaining portion of the first trading order through at least one liquidity provider registered with the trading platform based on the determination.

### Description

Various examples of the disclosure are discussed in detail below. While specific implementations are discussed, it should be understood that this is done for illustration purposes only. A person skilled in the relevant art will recognize that other components and configurations may be used without parting from the spirit and scope of the disclosure.

References to one or an example embodiment in the present disclosure can be, but not necessarily are, references to the same example embodiment; and, such references mean at least one of the example embodiments.

Reference to “one example embodiment” or “an example embodiment” means that a particular feature, structure, or characteristic described in connection with the example embodiment is included in at least one example of the disclosure. The appearances of the phrase “in one example embodiment” in various places in the specification are not necessarily all referring to the same example embodiment, nor are separate or alternative example embodiments mutually exclusive of other example embodiments. Moreover, various features are described which may be exhibited by some example embodiments and not by others. Similarly, various features are described which may be features for some example embodiments but not other example embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to limit the scope of the disclosure, examples of instruments, apparatus, methods and their related results according to examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular examples only and is not intended to be limiting. As used herein, the singular forms “a”, “an”, and “the” are intended to include the plural forms as well, unless the context clearly indicates otherwise. It will be further understood that the terms “comprises”, “comprising,”, “includes,” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures and techniques may be shown without unnecessary detail in order to avoid obscuring examples.

In the following description, illustrative examples will be described with reference to acts and symbolic representations of operations (e.g., in the form of flow charts, flow diagrams, data flow diagrams, structure diagrams, block diagrams, etc.) that may be implemented as program services or functional processes include routines, programs, objects, components, data structures, etc., that perform particular tasks or implement particular abstract data types and may be implemented using hardware at network elements. Non-limiting examples of such hardware may include one or more Central Processing Units (CPUs), digital signal processors (DSPs), application-specific-integrated-circuits, field programmable gate arrays (FPGAs), computers or the like.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

In the Background Section above, several flaws of current markets (e.g., OTC markets) are described. Hereinafter, an OTC market place system is presented and described that addresses the flaws listed above. Examples of this new OTC market place system include an OTC barter system (OBS) capable of providing a multi-level liquidity pool that, compared to currently existing OTC market places, lowers risk level, increases market transparency, provides and guarantees better pricing and offers a reliable execution system. OBS works on the basis of barter rules and spot trade details and creates a proper, safe and reliable new generation market place system. OBS also reduces market cost which can open new horizons to lower market spreads for the betterment of all market participants. Hereinafter, various aspects and examples of OBS will be described. However, before doing so, we will introduce a terminologies and concepts that will be referenced and used throughout the disclosure.

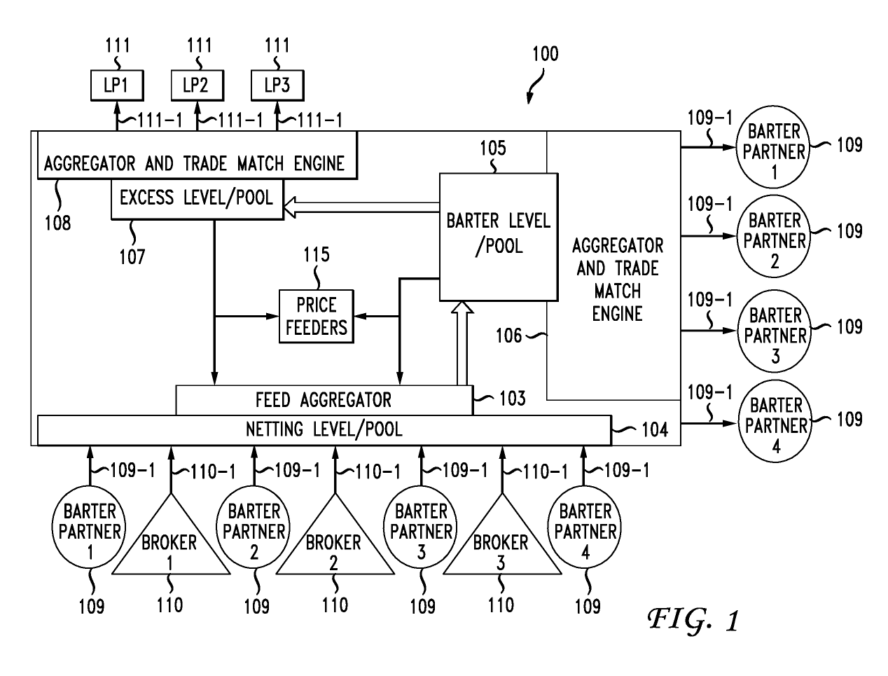

OBS market place is an entire system with various components, which will be further described below with reference to FIG. 1. OBS market place includes an OBS pool which refers to an exchange house that is the center of OBS market place. OBS market place further includes an OBS core, which is a set of computer-readable instructions being executed by one or more processors to make the OBS pool available to market participants and deliver the entire operational methodology of OBS market place, as will be described below. OBS provider refers to an institution (e.g., a bank, a financial institution, etc.) that provides OBS market place to interested market participants to facilitate trading therebetween. Hereinafter, OBS core is used to encompass the OBS, the OBS pool and the OBS provider defined above.

OBS core has multiple levels through which a trade sequentially moves to be cleared. These levels are referred to as barter level (where attempts are made to clear a trade via bartering as will be described below), an excess level (where any remaining and excess level of open positions/exposures of market participants are cleared with one or more liquidity providers) and one or more nettling levels, all of which will be described below.

Market participants can register with OBS provider as one or more of barter partner (BP), a broker and a liquidity provider (UP), the roles of each of which in OBS market place will be defined and described below.

FIG. 1 illustrates an example of a market place, according to an aspect of the present disclosure. As mentioned above, a market place (an OBS market place) can be defined as a complete system in which parties, through their corresponding trading platforms connect to what is referred to as a core (liquidity pool) and participate in selling and buying various types of products (e.g., financial products).

In FIG. 1, market place 100 includes an OBS core 102, which may also be referred to as OBS liquidity pool 102, OBS pool 102 and/or liquidity management system 102. Furthermore, market place 100 can also be referred to as OBS market place 100 or OBS market 100.

In one example, OBS core 102 of FIG. 1, is a multi-level pool that includes an aggregator 103, a netting pool (netting level) 104, a barter level pool (barter pool or barter level) 105, aggregator 106, an excess level pool (excess pool or excess level) 107 and aggregator 108.

Market place 100 can also have various market participants connected to OBS core 102. For example, market participants registered as barter partners (BPs) (e.g., BPs 1, 2, 3 and 4 (designated with reference numeral 109 in FIG. 1)) can connect to OBS core 102 via respective connections 109-1. Market participants registered as brokers (e.g., brokers 1, 2 and 3 (designated with reference numeral 110 in FIG. 1)) can connect to OBS core 102 via respective connections 110-1. Furthermore, market participants registered as liquidity providers (LPs) (e.g., LP1, LP2 and LP3 (designated with reference numeral 111 in FIG. 1)) can connection to OBS core 102 via respective connections 111-1.

Aggregator 103, aggregator 106 and aggregator 108 can each be a module configured to receive liquidity information from all market participants connected to OBS core 102 and combine (aggregate) the received liquidities into a single stream to be transmitted to all connected market participants. For example, aggregator 103 can receive liquidities from BPs 109 and brokers 110 in netting pool 104 as well as liquidities from barter pool 105 and/or excess pool 107 and combine them into a single stream to be transmitted back to BPs 109 and brokers 110 and/or to be forwarded to barter pool 105. Furthermore, aggregator 106 can receive liquidities provided by aggregator 103 to barter pool 105 and feed the same (together with trade information available at barter pool 105) back to BPs 109. Furthermore, aggregator 108 can receive liquidities from LPs 111 in excess pool 107 (together with trade information received at excess pool 107 from barter pool 105) and transmit aggregated liquidities/trade information back to LPs 111. In one example, aggregators 106 and 108 can also be referred to as aggregator and trade match engine 106 and 108, respectively.

As indicated above, market place 100 further includes different types of market participants (MPs). Market participants can use any type of known or to be developed platform such as an application program interface (API), gateways and bridges, through which a party (e.g., a trading party) can connect to OBS core 102 for taking part in a transaction.

As shown in FIG. 1, some MPs can register with OBS core 102 as bartering partners (BPs) 109. Each BP 109 can communicate with OBS core 102 via any known, or to be developed, communication means 109-1 (e.g., wired and/or wireless communication means). BPs 109 can engage in both buying and selling exposures open positions such as various types of financial products (e.g., stocks, bonds, currencies, etc.). Therefore, in FIG. 1, communication between BPs 109 and OBS core 102 are illustrated as a bi-directional communication.

Furthermore, some MPs can register with OBS core 102 as brokers 110. Each broker 110 can communicate with OBS core 102 via any known, or to be developed, communication means 110-2 (e.g., wired and/or wireless communication means). Brokers 110, as will be described below, are only engaged in clearing their open positions exposures through OBS core 102. Therefore, in FIG. 1, communication between brokers 110 and OBS core 102 are illustrated as a unidirectional communication from each broker 110 to OBS core 102.

Moreover, some MPs can register with OBS core 102 as liquidity providers (LPs) 111. Each LP 111 can be any type of financial institution, bank, etc., and can communicate with OBS core 102 via any known, or to be developed, communication means 111-1 (e.g., wired and/or wireless communication means). LPs 111, as will be described below, are only engaged in clearing open positions of OBS core 102, which servers to provide sufficient liquidity to the market. Therefore, in FIG. 1, communication between LPs 111 and OBS core 102 are illustrated as a unidirectional communication from OBS core 102 to each LP 111.

While a specific number of each type of market participant (e.g., BPs, brokers and LPs) is shown in FIG. 1, the present disclosure in not limited thereto and any number of market participants, from a few to thousands and more, can interact through their respective platforms and OBS core 102 to engage in and conduct trading. Furthermore, BPs 109, brokers 110 and LPs 111 may collectively be referred to, hereinafter, as simply market participants.

Furthermore, for sake of simplicity and better explanation of the direction of traders/clearing, BPs 109 are shown in FIG. 1 to be connected separately to netting pool 104 (for placing trades with OBS core 102) and barter pool 105 (for clearing/accepting trades with OBS core 102). However, these separately shown MPs 109 can be the same (e.g., BP 1 shown horizontally at the bottom of OBS core 102 can be the same as BP 1 shown vertically to the right of OBS core 102).

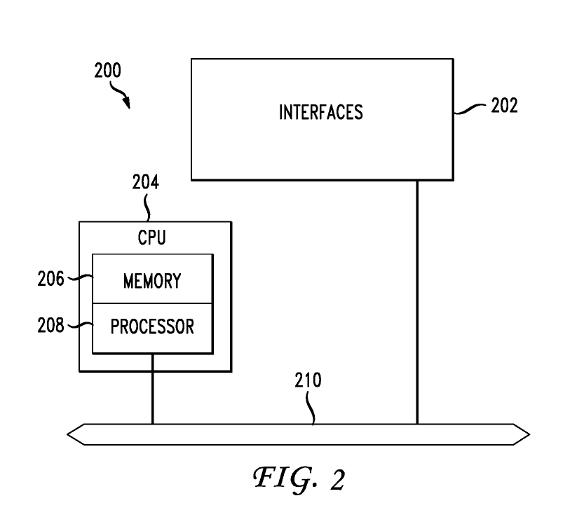

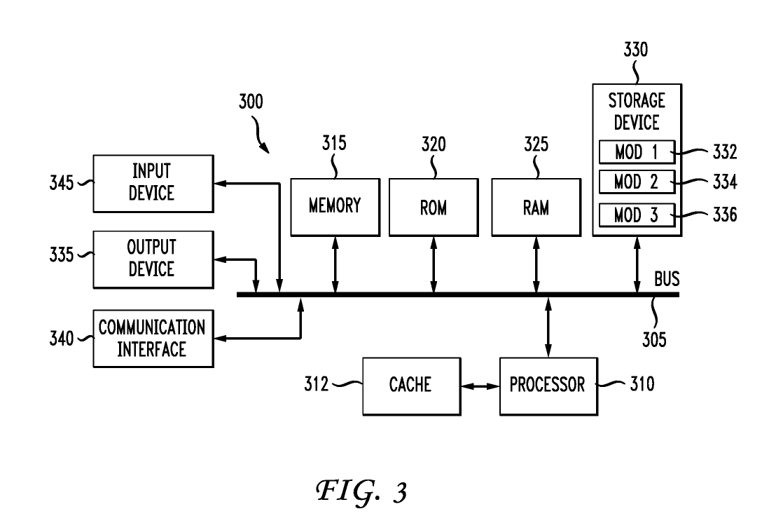

Various hardware and software components of OBS market place 100, an interaction among which enables the creation and functioning of OBS market place 100 will be further described with reference to FIGS. 2 and 3.

OBS core 102 can be a pool through which market participants can exchange/trade, various (any type) of products, including but not limited to, various types of Over the Counter (OTC) commodities and financial products. Such products include, but are not limited to, stocks, futures, commodities, currencies, metals, raw material, derivatives, insurance, mortgages, bonds, government securities, certificates of deposit, credit default swaps, collateralized debt obligations, contract for differences, etc.

The OBS market place created through interaction of OBS core 102 with market participants such as BPs 109, brokers 110 and LPs 111, can be any known, or to be developed, type of market including, but not limited to, an insurance finance market, a syndicated load market, a religious based finance market an Islamic finance market), etc., and/or any combination thereof.

BPs 109, brokers 110 and LPs 111 (market participants) can be any one of, but not limited to, a broker, a bank, an institutional investor, an investment bank, insurance providers, credit card agencies, government sponsored entities, etc. Market participants can register with OBS core 102 for conducting trades using any known or to be developed electronic device that is capable of connecting to remote devices (including OBS core 102) over the Internet.

Through execution of appropriate computer-readable instructions, OBS core 102 can control and manage executions of trades, methods of trade, settlements and risk measurements. OBS core 102 can also navigate market liquidity.

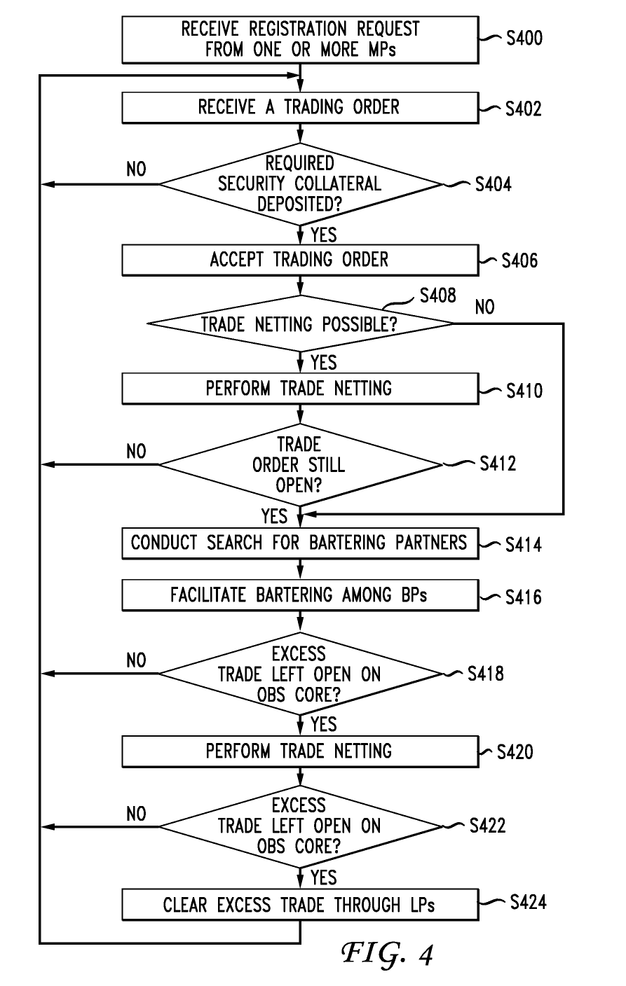

OBS core 102, as mentioned above, can be a multi-level liquidity pool with nettling pool 104, barter pool 105, netting pool 106 and excess pool 107. A pool can simply refers to a collection of trades. For example, nettling pool 104 refers to a collection of trades (every trade received at OBS core 102). Two or more trades in netting pool 104 can have opposite order types (e.g., buy v. sell) for the same symbol or product (e.g., same stock, commodity, currency exchange, etc.) such that the trades (or at least portions thereof) can be cleared with one another (this, as will be described below with reference to FIG. 4, is referred to a trade netting process).

Barter pool 105 refers to a collection of open exposures and trades that, after going through the trade netting process, still have at least a portion thereof open. OBS core 102 can then attempt to clear the trades in barter pool 105 through a process of bartering trades (bartering process), as will be described below with reference to FIG. 4.

Finally, excess pool 107 is a pool of trades that, after going through the trade netting processes and a bartering process, are still open. These trades are referred to as excess trades. Herein and as will be described below, OBS core 102 clears the excess trades through LPs 111.

Accordingly, a trade placed by a market participant in OBS core 102, sequentially moves through multiple pools, as shown by arrow 112, where at each stage, OBS core 102 attempts to clear the entirety or a portion thereof. Therefore, in one example, the size of each pool (number of trades in each pool) are reduced as we move from netting pool 104 to excess pool 107, since at each stage of this sequential move, a number of trades placed with OBS core 102 are cleared. This will be further described below with reference to FIG. 4.

Furthermore, as shown in FIG. 1, OBS core 102 can also have a price feeder 115, which can collect various prices (offered and asked prices) for various products dealt between MPs via OBS Core 102. For example, price feeder 115 can receive (monitor) information on various prices from excess pool 107, barter pool 105 and netting pool 104 as such information are exchanged between these pools. This would in turn provide better market transparency and lower market volatility for all MPs participating in placing/clearing deals with OBS core 102.

In addition to various components of OBS market place 100 described above, OBS market place 100 can have other components associated therewith. For example, OBS core 102 can have a payment processing system for processing payments associated with the trades conducted by market participants on OBS core 102 (e.g., for processing payments made for security collateral, clearing trades, etc.). The payment processing system can be any know or to be developed payment processing system. Furthermore, OBS core 102 can provide market participants (BPs, brokers and LPs) with market depths. As OBS market place is a completely transparent market place, ail market participants can request to trace and track their trades. In response to such requests, OBS core 102 can provide all market participants with the ability (e.g., data log, visual display, etc.) to trace and track their trades.

One aspect of OBS core 102 is that market participants 104 can register with OBS core 102 and function as different types of market players. For example, a market participant can register with OBS core 102 as a BP 109. A registered BP 109 can act as a broker 110 and/or an LP 111. While a BP can offset its exposure with OBS core 102, the same BP can also be a LP to accept one or more exposures of OBS pool. By allowing BPs to function as LPs and/or brokers, OBS core 102 enables an expansion of market depth and increases OBS core pool users (market participants). With an increase in market participants, number of liquidity providers can also increase and with distribution of trades among many market participants, risk in OBS market place is lowered.

In one example, an LP cannot offset its exposure (open trades) with OBS pool but can only clear (receive) any excess level exposure of OBS core 102 that is present in excess pool 107. On the other hand, a broker 110 can offset its exposure with OBS core 102 but will not receive any exposure trout OBS core 102. Therefore, when a market participant registers with OBS core 102 as a broker 110, such market participant cannot function as BP 109 or an LP 111. Furthermore, when a market participant register with OBS core 102 as a LP, such market participant cannot function as a broker 110 or BP 109.

One aspect of OBS core 102 is that it enables different market participants to barter with one another (e.g., exchange trades with trades) before resorting to liquidity providers in order to clear their trades. This will be further described below.

Another aspect of OBS core 102 is that, relative to traditional exchanges and OTC markets, market participants such as brokers, only need to deposit a small amount of cash (security collateral) with OBS core 102 for conducting trades (e.g., only 25% of the value of their trades). This is referred to as a barter credit method (BCM). In this method, after a market participant has met credit rating and other relevant requirements, the market participant deposits only a small amount (e.g., 25% of the value of their trade) with OBS core 102. This will also be further described below.

In view of the above and relative to existing OTC platforms, the exposure of market participants to market volatility (market risk) and financial soundness of liquidity providers as well as counterparty risks (e.g., BP risks) are reduced.

FIG. 2 illustrates an example network device suitable for performing switching, routing, load balancing, and other networking operations, according to an aspect of the present disclosure. In one example, network device 200 can be the same as OBS core 102 or any one of BPs 109, brokers 110 and/or LPs 111, described above with reference to FIG. 1. Network device 200 includes a central processing unit (CPU) 204, interfaces 202, and a bus 210 (e,g., a PCI bus). When acting under the control of appropriate software or firmware, CPU 204 is responsible for executing packet management, error detection, and/or routing functions, CPU 204 preferably accomplishes all these functions under the control of software including an operating system and any appropriate applications software, CPU 204 may include one or more processors 208, such as a processor from the INTEL X86 family of microprocessors. In some cases, processor 208 can be specially designed hardware for controlling the operations of network device 600. In some cases, a memory 606 (e.g., non-volatile, RAM, ROM, etc.) also forms part of CPU 604. However, there are many different ways in which memory could be coupled to the system.

Interfaces 202 are typically provided as modular interface cards (sometimes referred to as “line cards”). Generally, they control the sending and receiving of data packets over the network and sometimes support other peripherals used with network device 200. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master microprocessor 204 to efficiently perform routing computations, network diagnostics, security functions, etc.

Although the system shown in FIG. 2 is one specific network device of the present invention, it is by no means the only network device architecture on which the present invention can be implemented. For example, an architecture having a single processor that handles communications as well as routing computations, etc., is often used. Further, other types of interfaces and media could also be used with network device 200.

Regardless of the network device's configuration, it may employ one or more memories or memory modules (including memory 206) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 206 could also hold various software containers and virtualized execution environments and data.

Network device 200 can also include an application-specific integrated circuit (ASIC), which can be configured to perform routing and/or switching operations. The ASIC can communicate with other components in network device 200 via bus 210, to exchange data and signals and coordinate various types of operations by network device 200, such as routing, switching, and/or data storage operations, for example.

FIG. 3 illustrates a computing system architecture, according to an aspect of the present disclosure. As shown in FIG. 3, components of system 300 are in electrical communication with each other using a connection 305, such as a bus. Exemplary system 300 includes a processing unit (CPU or processor) 310 and a system connection 305 that couples various system components including system memory 315, such as read only memory (ROM) 320 and random access memory (RAM) 325, to processor 710. System 300 can include a cache of high-speed memory connected directly with, in close proximity to, or integrated as part of the processor 310. System 300 can copy data from memory 315 and/or storage device 330 to cache 312 for quick access by processor 310. In this way, the cache can provide a performance boost that avoids processor 310 delays while waiting for data. These and other modules can control or he configured to control the processor 310 to perform various actions. Other system memory 315 may be available for use as well. Memory 315 can include multiple different types of memory with different performance characteristics. Processor 310 can include any general purpose processor and a hardware or software service, such as Service 1 332, Service 2 334, and Service 3 336 stored in storage device 330, configured to control processor 310 as well as a special-purpose processor where software instructions are incorporated into the actual processor design. Processor 310 may be a completely self-contained computing system, containing multiple cores or processors, a bus, memory controller, cache, etc. A multi-core processor may be symmetric or asymmetric.

To enable user interaction with the computing device 300, an input device 345 can represent any number of input mechanisms, such as a microphone for speech, a touch-sensitive screen for gesture or graphical input, keyboard, mouse, motion input, speech and so forth. An output device 335 can also be one or more of a number of output mechanisms known to those of skill in the art. In some instances, multimodal systems can enable a user to provide multiple types of input to communicate with computing device 300. The communications interface 340 can generally govern and manage the user input and system output. There is no restriction on operating on any particular hardware arrangement and therefore the basic features here may easily be substituted for improved hardware or firmware arrangements as they are developed.

FIG. 4 describes a method of facilitating and managing trades by OBS core of FIG. 1, according to an aspect of the present disclosure. FIG. 4 is described from the perspective of OBS core 102. However, those having ordinary skill in the art would readily understand that the functions performed by OBS core 102 is carried out by one or more processors implementing one or more set of instructions stored on one or more memories as described above with reference to FIGS. 2 and 3, which transform the one or more processors into a special purpose processor for implementing the functionalities of OBS core 102 described hereinafter.

At S400, OBS core 102 receives a registration request from one or more market participants to register with OBS core 102 as a market player. As described above, any one market participants can register as one of a BP (e.g., one of BPs 109), a broker (e.g., one of brokers 110) or a liquidity provider (e.g., one of LPs 111), as shown and described above with reference to FIG. 1. OBS core 102 then registers anyone of market participants from which a registration request is received (e.g., by having market participants provide relevant information, agree to terms and conditions, etc.).

Upon registration of one or more market participants with OBS core 102, at S402, OBS core 102 receives a trading order (e.g., sell or buy) from a registered market participant. For example, OBS core 102 receives an order (a currency trade order) to buy $1M of EURUSD from a BP 109. The trading order received at S402 can have a requested price, (e.g., a bid price) associated therewith.

At S404, OBS core 102 determines if required security collateral has been deposited by the registered BP 109 from which a trading order is received at S402. The required security collateral can be agreed upon between OBS core 102 and BP 109 at S400 or before the trader is processed. For example, the required security collateral can be set to 25% of BP 109's average daily trading value. In the above example of a trade valued at $1M, BP 109 has to deposit $250,000 with OBS platform 102. Other benchmarks can also be used for determining the amount of required security collateral (e.g., average weekly trades of BP 109, average daily trades of BPs that conducts sales having more or less the same volume or value on a daily, weekly, monthly, annually basis, as BP 109, etc).

If at S404, OBS core 102 determines that the required security collateral is not deposited by BP 109, then OBS core 102 informs BP 109 to make the required deposit before the trade can be processed.

If at S404, OBS core 102 determines that the required security collateral is deposited by BP 109, then at S406, OBS core 102 accepts the trading order (e.g., the $1M buy order for EURUSD, described above) received at S402.

At S408, OBS core 102 determines if trade netting (which may also be referred to as trade netting process or simply netting process) is possible. Trade netting refers to process according to which at least a portion of a trade can be cleared with an opposite order type for the same symbol or product (depending on factors such as the buy and sell asking prices, etc.) available in netting pool 104. In other words and in the example of the buy order for $1M in EURUSD, the trade netting process determines if a sell order (which is opposite the buy order type) for a certain amount (e.g., more or less or equal to $1M EURUSD) exist in the pool so that the two orders (or at least a portion thereof) can be cleared with one another.

Accordingly, in performing S408, OBS core 102 determines if at least one trade of the same symbol or product for which the trading order is received at S402, exists in netting pool 104 and if such at least one trade has an opposite order type relative to the order type of the trading order received at S402. If at least one such trade exists in netting pool 103, then OBS core 102 determines that trade netting is possible.

If at S408, OBS core 102 determines that trade netting is possible, at S410 OBS core 102 performs the trade netting process to clear at least a portion of the trade order received at S402. However, if at S408, OBS core 102 determines that trade netting is not possible, OBS core 102 skips S410 and proceeds to S414 as will be described below.

At S412, OBS core 102 determines if any portion of the trading order received at S402 is still open (outstanding) after performing the trader netting process at S410. If at S412, OBS core 102 determines that the trade order received at S402 has been cleared through the trade netting process at S410 then the process reverts back to S402 where OBS core 102 repeats S402 to S412. In one example and after S412, the process may revert back to S400 instead of S402 when a new market participant is first joining/attempting to register with OBS core 102.

However, if at S412, OBS core 102 determines that the trade order received at S402 is still open (at least a portion thereof is open) after the trade netting process of S410, then at S414, OBS core 102 conducts a search for bartering partners. In other words, OBS core 102 conducts a search among trades available in barter pool 105 in order to determine if any comparable orders by one or more other BPs (e.g., order(s) by other BPs 109) have been placed with OBS core 102 so that OBS core 102 can exchange/barter the remaining portion of the trading order received at S402 with one or more such comparable orders/trades. This search can be for trades with similar and/or same bid/ask prices as that of the trading order received at S402.

In one aspect of the present disclosure, as numbers of participants in barter pool 105 of OBS core 102 is more than currently existing OTC market places, the catching (desired) prices are much easier to come across and also results in very tight spreads in bid/ask prices. Furthermore, OBS core 102 has the advantage that when one BP rejects a trade (e.g., the trading order received at S402), OBS core 102 does not reject the trade but simply searches for other available trades by other BPs 109 willing to barter trades.

For example, in addition to the trading order at S402 received at OBS core 102, another order to sell $1M of GBPUSD is also received for sale on OBS core 102. This sell order could have been placed by another BP 109 registered with OBS core 102. In another example, instead of one sell order for $1M of GBPUSD, OBS core 102 can have several smaller sell orders available thereon (e.g., sell order for $200K on EURUSD, sell order for $500K of gold and sell order for $250 k of stocks of company A).

If at S414, OBS core 102 determines that at least one comparable order (e.g., sell order) exists in barter pool 105, then at S416. OBS core 102 facilitates a bartering process between BP 109 (from which the buy trading order at S402 is received) and one or more of BPs 109 (from which the sell trading order(s) are received, as in the example described above). In other words, OBS core 102 enables BPs 109 to exchange (barter) a buy order for $1M of EURUSD with a sell order of $1M of GBPUSD (or in the example above, with one or more of sell order for $200K on EURUSD, sell order for $500K of gold and sell order for $250 k of stocks of company A).

At S418, OBS core 102 determines if there are any excess trades left on OBS core 102, after the trade netting and bartering processes of S408 to S416, that need to be cleared. For example, in performing S416, OBS platform 102 may only be able to allow trade netting and bartering of half of the example buy order for $1M of EURUSD. For example, at S416, OBS platform 102 is able to complete (fulfill) $250K of the $1M buy order on EURUSD through the trade netting process and $500 k of the $1M buy order of EURUSD through the bartering process with $500K sell order on GBPUSD. Accordingly, OBS core 102 determines that a trade/exposure amounting to $25K of the $1M buy order on EURUSD is still open.

If at S418, OBS core 102 determines that no excess trade is left open on OBS core 102, the process reverts back to S402 and OBS core 102 repeats S402 to S418 (or S400 to S418 if a new market participant is attempting to register and place an order with OBS core 102). However, if at S418, OBS core 102 determines that there is at least one excess trade left open on OBS core 102 then at S420, OBS core 102 performs another trade netting in an attempt to clear the open portion of the trading order received at S402. This trade netting process is performed in exactly the same manner as S408 and S410 described above.

At S422, OBS core 102 determines if there are any excess trades left open after performing the trade netting process at S420. If at S422, OBS core determines that no excess trade is left open after the trade netting process at S420, the process reverts back to S402 and OBS core 102 repeats S402 to S422 (or S400 to S422 if a new market participant is attempting to register and place an order with OBS core 102).

However, if at S422, OBS core 102 determines that there is at least one excess trade left open on OBS core 102 after S420, then at S424, OBS core 102 clears the excess trade using one or more liquidity providers that are wining to do so and are registered with OBS core 102 to clear the remaining portion of the buy order for $1M of EURUSD).

Thereafter, the process reverts back to S402 and OBS core 102 repeats S402 to S424 (or S400 to S424 if a new market participant is attempting to register and place an order with OBS core 102).

In one example, a market participant can register as a broker with OBS core 102 such as broker 110. Accordingly, when a trading order is received from a broker 110 at S402, broker 110 is interested in clearing the trading order with OBS core 102 as a liquidity provider and does not receive any exposure (open positions) in exchange, from other market participants via OBS core 102. In other words, OBS core 102 functions as a LP for broker 110. Therefore, by performing S410-S424, broker 110 clears its position (trading order) with OBS core 102.

Examples of OBS core 102 and the process implemented thereby, as described above, provide various advantages over existing systems that provide an OTC trading platform.

OBS core 102 and the process implemented thereby (1) enables market participants, BPs and brokers to keep less cash (security collateral) with OBS core 102, compared to what brokers have to keep with liquidity providers in current OTC trading markets; (2) enables reduction in vulnerability to financial hardship of counterparties and liquidity providers because of said lower deposit with liquidity providers; (3) enables lowering of market risk where there is market volatility due to an aggressive trading; (4) enables market participants, BPs and brokers to keep more cash in house to maintain withdrawal of their clients and thus increase their service quality for their clients; (5) enables market participants, BPs and brokers to clear more volume of trades they are exposed to given the availability of more cash in house; (6) enables reduction in backing transaction fees and thus providing cheaper service for clients; (7) spreads the overall risk among a large number of market participants; (8) eliminates any top of the book liquidity issues; (9) offers diversified settlement options in the event and instance of large trade volumes; (10) increases market depth; and (11) enables reduction in spreads and better execution due to lower overall costs; and (12) increases flexibility between market participants in case of leverage and contracts. Given that the retail participants can be one of the main market players (e.g., a liquidity provider), OBS core 102 results in no concentration and/or monopolization in market participation (as opposed to the case currently in OTC markets with very few liquidity providers practically controlling and dictating market behavior).

For clarity of explanation, in some instances the present technology may be presented as including individual functional blocks including functional blocks comprising devices, device components, steps or routines in a method embodied in software, or combinations of hardware and software.

In some examples the computer-readable storage devices, mediums, and memories can include a cable or wireless signal containing a hit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations.

Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

We claim:

1. A system comprising:
at least one memory having computer-readable instructions stored therein; and
one or more processors configured to execute the computer-readable instructions to,
receive a first trading order from a first market participant;
perform a first process for enabling a bartering of the first trading order with at least one second trading order received from a second market participant; and
when the first process does not result in a complete clearing of the first trading order, perform a second process to clear any remaining portion of the first trading order through at least one liquidity provider registered with the trading platform.

2. The system of claim 1, wherein the first trading order is for buying a first product and the at least one second trading order is for selling a second product.

3. The system of claim 1, wherein the first market participant is a first bartering partner registered with the trading platform.

4. The system of claim 3, wherein the second market participant is a second bartering partner registered with the trading platform.

5. The system of claim 4, wherein the at least one liquidity provider is any one of the first bartering partner and the second bartering partner.

6. The system of claim 1, wherein when the first process results in the complete clearing of the first trading order, the one or more processors skip performing the second process.

7. The system of claim 1, wherein the execution of the computer-readable instructions further configure the one or more processors to:
register a plurality of market participants as at least one of a bartering partner and a liquidity provider on the trading platform; and
request and receive a portion of each market participants trading value as a security collateral.

8. The system of claim 7, further comprising:
a plurality of platforms through which the plurality of market participants conduct trading.

9. The system of claim 1, wherein the execution of the computer-readable instructions further configure the one or more processors to:
perform a third process for completing the first trading order prior to performing the first process, the third process being a trade netting process according to which at least a portion of the first trading order is cleared with at least one other trading order having an opposite order type of the same underlying symbol or product of the first trading order.

10. The system of 9, wherein the execution of the computer-readable instructions further configure the one or more processors to:
perform a fourth process for completing the first trading order prior to performing the second process, the fourth process being a trade netting process according to which at least any open portion of the first trading order is cleared with at least one other trading order having an opposite order type of the same underlying symbol or product of the first trading order.

11. The system of claim 1, wherein the system has a payment processing system configured to process payments resulting from trades completed via the system.

12. A non-transitory computer-readable medium having computer-readable instructions stored thereon, which when executed by one or more processors, cause the one or more processors to:
receive a first trading order from a first market participant;
perform a first process for enabling a bartering of the first trading order with at least one second trading order received from a second market participant;
determine whether the first process resulted in a complete clearing of the first trading order, to yield a determination; and
perform a second process to clear any remaining portion of the first trading order through at least one liquidity provider registered with the trading platform based on the determination.

13. The non-transitory computer-readable medium of claim 12, wherein the first trading order is for buying a first product and the at least one second trading order is for selling a second product.

14. The non-transitory computer-readable medium of claim 12, wherein
the first market participant is a first bartering partner registered with the trading platform, and
the second market participant is a second bartering partner registered with the trading platform.

15. The non-transitory computer-readable medium of claim 13, wherein the at least one liquidity provider is any one of the first bartering partner and the second bartering partner.

16. The non-transitory computer-readable medium of claim 12, wherein the execution of the computer-readable instructions by the one or more processors further configure the one or more processors to:
register a plurality of market participants as at least one of a bartering partner and a liquidity provider on the trading platform; and
request and receive a portion of each market participants trading value as a security collateral.

17. A method comprising:
receiving a first trading order from a first market participant;
performing a first process for enabling a bartering of the first trading order with at least one second trading order received from a second market participant;
determining whether the first process resulted in a complete clearing of the first trading order, to yield a determination; and
performing a second process to clear any remaining portion of the first trading order through at least one liquidity provider registered with the trading platform based on the determination.

18. The method of claim 17, wherein
the first trading order is for buying a first product and the at least one second trading order is for selling a second product,
the first market participant is a first bartering partner registered with the trading platform,
the second market participant is a second bartering partner registered with the trading platform, and
the at least one liquidity provider is any one of the first bartering partner and the second bartering partner.

19. The method of claim 17, further comprising:
performing a third process for completing the first trading order prior to performing the first process, the third process being a trade netting process according to which at least a portion of the first trading order is cleared with at least one other trading order having an opposite order type of the same underlying symbol or product of the first trading order.

20. The method of claim 19, further comprising:
perform a fourth process for completing the first trading, order prior to performing the second process, the fourth process being a trade netting process according to which at least any open portion of the first trading order is cleared with at least one other trading order having an opposite order type of the same underlying symbol or product of the first trading order.
